(19) United States
(12) Patent Application Publication
(10) Pub. No.: US 2011/0134203 A1
(43) Pub. Date: Jun. 9, 2011

(54) MEDICAL VIDEO CALL DISTRIBUTOR

(76) Inventors: Vladimir Smelyansky, Glenview, IL (US); Patricia Mathis, West Palm Beach, FL (US)

(21) Appl. No.: 12/630,472

(22) Filed: Dec. 3, 2009

(51) Int. Cl. H04N 7/14; H04N 7/18

(52) U.S. Cl. 348/14.01; 725/78; 348/E07.077

(57) ABSTRACT

A central switch is linked to at least one field video station (FVS) and at least one remote specialist video station (SVS) via a communication network, typically the Internet. Each FVS station includes a medical device associated with a patient and operated by an operator. The medical device generates patient test data. A two-way audio system is installed in the station. A video camera provides an overview of the FVS. A local computer executes software for processing patient and camera data as streaming video for transmission to the network along with two-way audio. Each SVS includes a processor for receiving, converting and displaying the streaming video along with receiving and transmitting two-way audio. The FVS and the SVS interact via the network after the specialist registers with a management system in the central switch, and is selected by the technician. During interaction, the specialist is able to view, diagnose and counsel the patient; instruct the operator operating the medical device, and change communication and video parameters.

### FIELD

This invention relates to network based medical systems, methods and program products. More particularly, the invention relates to network based patient monitoring, diagnosis and treatment via remote specialists viewing associated patient medical devices via real-time streaming video and interactive audio among specialists, medical device technicians, patients and others at a site servicing the patient.

### BACKGROUND

With an expanding world population and a limited supply of medical specialists to service patients using complex medical devices, e.g., X-Ray, MRI, etc., there is a need to (i) expand the availability of such specialists to patients, particularly patients at remote locations, and (ii) provide real-time test results of such medical devices for patients under treatment by the specialist.

The present invention provides real-time image streaming accompanied by audio for patients at different locations to a specialist at another location, the specialist having the ability (i) to observe test results of complex medical devices servicing the patient; (ii) instruct a technician operating the medical device in performing the tests, and (iii) counsel the patient with regard to treating the medical condition.

### SUMMARY

A Medical Video Call Distributor (MVCD) comprises a central switch, typically a computer including memory linked to remote video stations servicing patients via a communications network, typically the Internet. Each video station is linked to a medical device associated with a patient. The medical device transmits patient test data and video showing patient results from the operation of the medical device by a technician. A video camera provides video of the medical device, video station, technician and patient. A local computer executes software for processing the patient test data and video as streaming video, and is coupled to the central switch as part of a field one-way transmitting video station (FVS). A specialist registers with a management system incorporated into the central switch. The management system includes a database containing programming for performing a registrar function; a billing function and an Automatic Call Distributor (ACD). The specialist is registered in an ACD queue for subsequent selection by a technician associated with a medical device servicing the patient. The specialist is linked to the central switch via a specialist video station (SVS).

The operation of the MVCD begins when a technician sends a request to the central switch for a specialist registered in the management system and listed in the ACD.

After selection of the registered specialist by the technician, two way audio and one-way video connections are established between the SVS and the FVS via the Internet using Session Initiated Protocols (SIP) and Session Description Protocols (SDP). The FVS starts streaming patient test data from the medical device and video to the SVS using the local video processing software. The (specialist video station) converts the streaming video into a format suitable for a video processing system and records the video in local storage. The specialist analyzes the stored or real-time video using pause, rewind, slow, etc. The specialist can view output of more than one medical device at a session and can provide voice instructions to the technician(s) to change medical device parameter, as necessary, to complete diagnosis and treatment of the patient. The specialist discusses the diagnosis and treatment with patient via the two way audio system. The session ends and the SVS and FVS are disconnected from the central switch.

### DRAWINGS

FIG. 1 is a representation of a Medical Video Call Distributor (MVCD) incorporating the principles of the present invention enabling a remote specialist at a Specialist Video Station (SVS) to service patients and associated medical devices at a Field Video Station (FVS) via a network including a central switch processing streaming one-way video and two way audio;

FIG. 2 is a representation of the FVS of FIG. 1;

FIG. 3 is a representation of a management system included in the central switch of FIG. 1;

FIG. 4-1 is a flow diagram of the Automatic Call Distributor (ACD) function included in the management system of FIG. 3 for identifying a remote specialist to provide services to patients;

FIG. 4-1A is a Session Initiated Protocol (SIP) diagram for connecting the FVS to the central switch;

FIG. 4-1B is a SIP diagram for connecting the SVS to the central switch;

FIG. 4-2 is a flow diagram of the Registrar function included in the management system of FIG. 3 providing registration services for the FVS, SVS and users of the MVCD system;

FIG. 4-3 is a block diagram of the Billing function included in the management system of FIG. 3 for collecting service information and generating invoices related to the services provided to a patient(s);

FIG. 5 is a flow diagram of a technician requesting and selecting medical services of a remote specialist for a patient via the ACD of FIG. 1;

FIG. 6A is a flow diagram of at least one Field Video Station (FVS) of FIG. 1 connecting to a Specialist Video Station (SVS) and establishing one-way streaming video and two-way audio with the SVS enabling a remote specialist to view a medical device(s) associated with a patient; instruct a technician in the operation of the medical device(s) and provide medical services to the patient, and

FIG. 6B is a SIP diagram establishing a connection between the FVS and SVS via the Internet of FIG. 1 enabling the remote specialist to perform the services of FIG. 6.

### DESCRIPTION OF PREFERRED EMBODIMENT

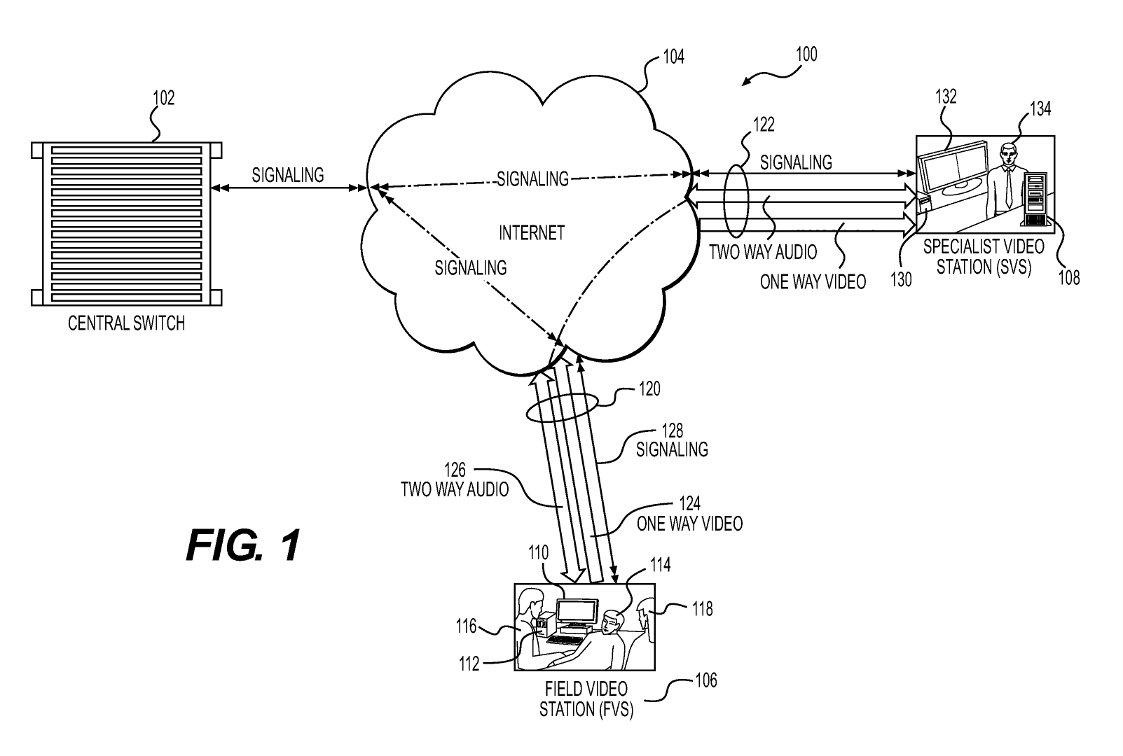

A medical video call distributor system 100, as shown in FIG. 1, includes a central switch 102 having a processor, Random Access Memory (RAM) and Read Only Memory (ROM). The switch is linked to a communications network 104, typically the Internet, servicing at least one Field Video Station (FVS) 106 for a patient and at least one Specialist Video Station (SVS) 108, the system enabling a remote Specialist to provide services to the patient. The stations 106 and 108 are coupled to the Internet 104 via connections 120 and 122, respectively. Each connection includes a one way video connection 124; a two way audio connection 126 and a signaling connection 128. Each FVS station includes a video station 110 for displaying and transmitting data of a medical device 112 servicing a patient 114. A technician 116 operates the medical device 112. Another person 118, e.g., nurse, friend, etc., may be with the patient. The SVS station 108 includes a computer 130 including a display 132 providing a split screen for viewing medical test data received from the medical device servicing the patient and an overview of the patient room. A specialist 134 views the display and communicates with technician and the patient via the connection 122 in diagnosing the patient's medical condition and instructing the technician with respect to the operation of the medical device.

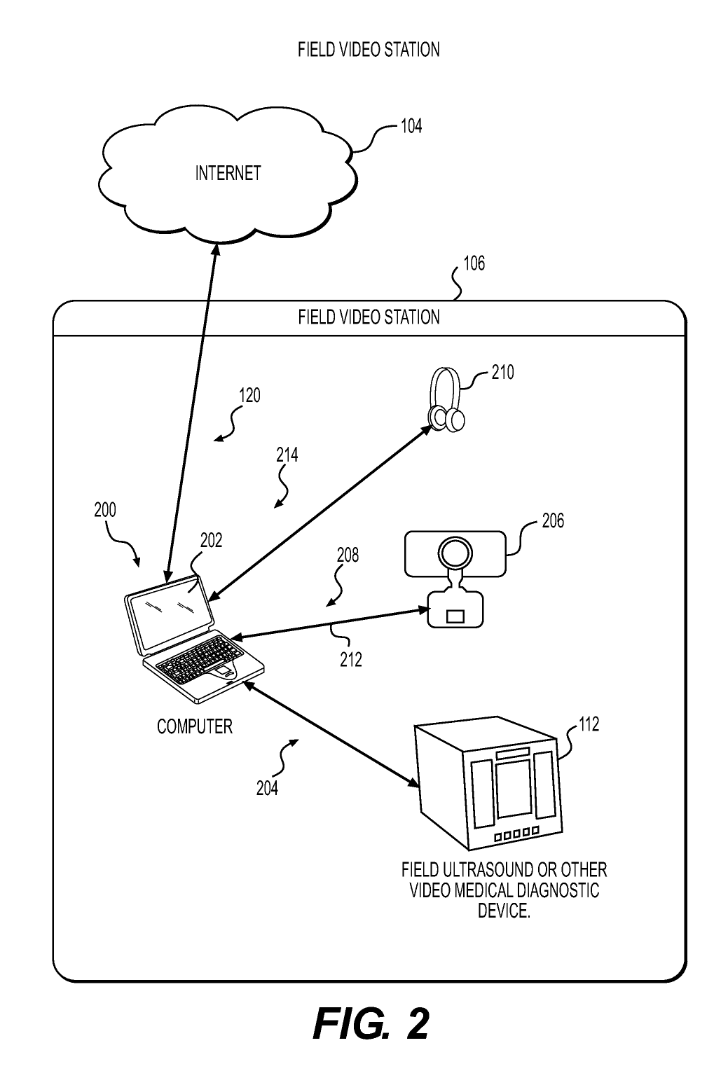

The FVS 106 is further described in FIG. 2 taken in conjunction with FIG. 1. A computer processor 200 including a display 202 and memory (not shown) is coupled to the Internet 104 via the connection 120 including the one-way video connection 124; the two way audio connection 126 and the signaling connection 128, as shown in FIG. 1. The computer 200 receives signals from the medical device 112 servicing a patient (not shown) via a connection 204 for display on the computer 200. A camera 206 is linked to the computer 200 via a connection 208. The camera 206 provides a video signal and an audio signal via the connection 208 to the computer 200 for transmission to the specialist video system. That transmission could occur over Internet 104 or some other type of wide area connection. The video signal provides an overview of the medical device, station, patient and technician for viewing by a specialist, as will be described hereinafter. At least one headset and speaker 210 are linked to the computer via a connection 214 for communication with the specialist. The computer software converts the video signals into one-way streaming video format for transmission to the Internet and distribution to a specialist, as will be described hereinafter.

Various communications protocol may be employed between each station 106 and the central switch 102 including Session Initiated Protocol (SIP), Transaction Control Protocol (TCP), User Datagram Protocol (UDP, Media Gateway Control Protocol (MGCP), H.323 or other digital packet communications systems. The present description, however, will be in terms of SIP (RFC 3261); Session Description Protocol (SDP) (RFC2327, RFC4796, RFC3407, RFC4566), and Real-time Transport Protocol (RTP) (RFC 1889, 3550).

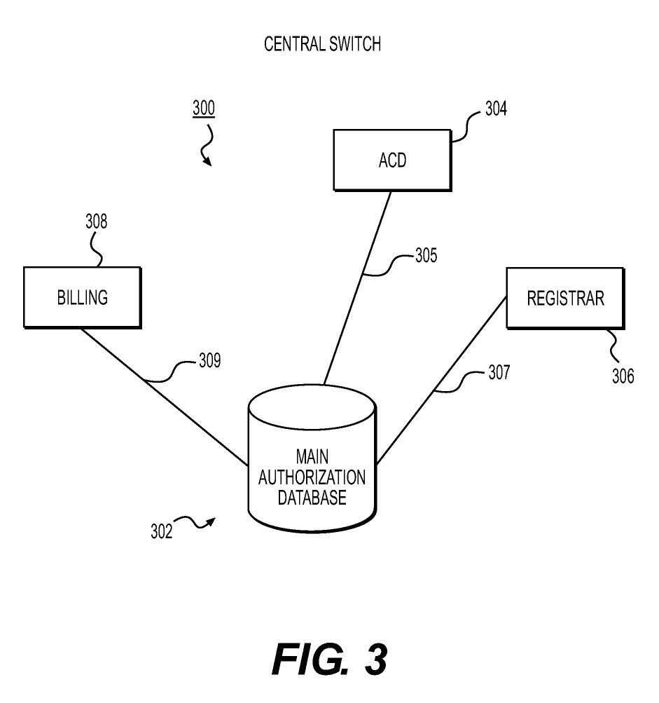

Turning to FIG. 3, taken in conjunction with FIG. 1, a management system 300 is included in the central switch 102. The system 300 includes a database 302 containing programmed software for performing an automatic call distributor (ACD) function 304; a Registrar function 306 and a Billing function 308.

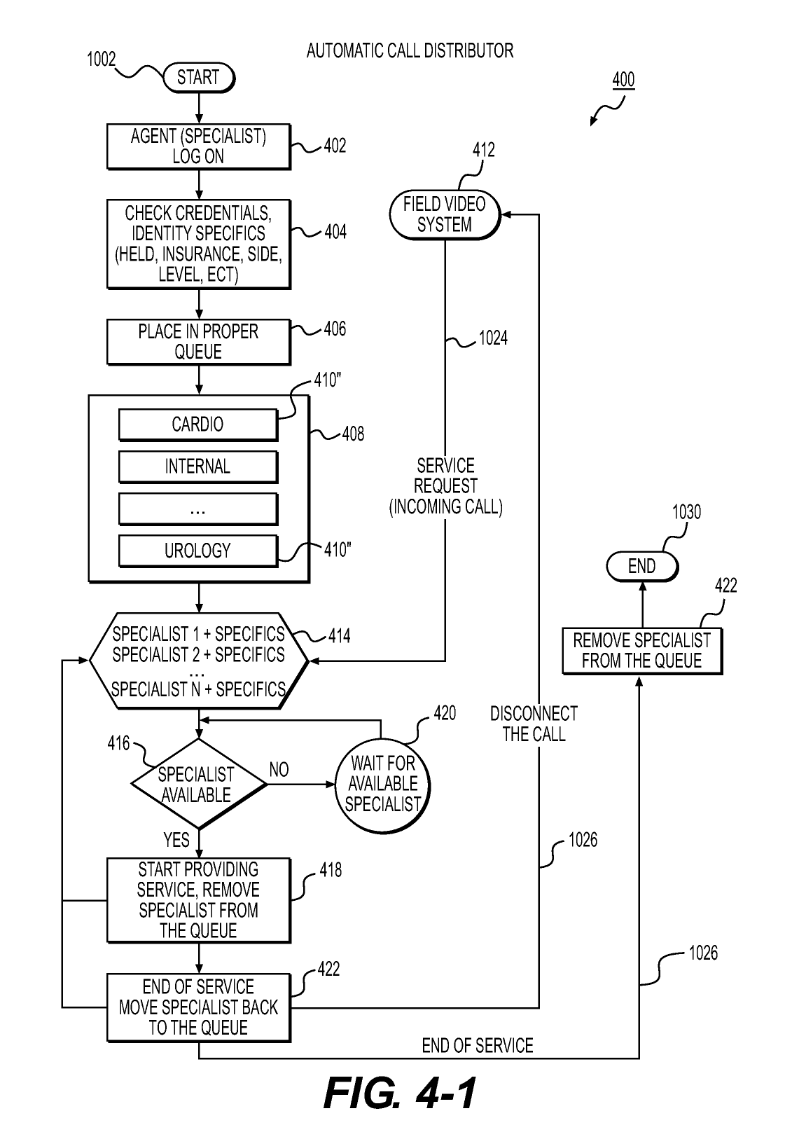

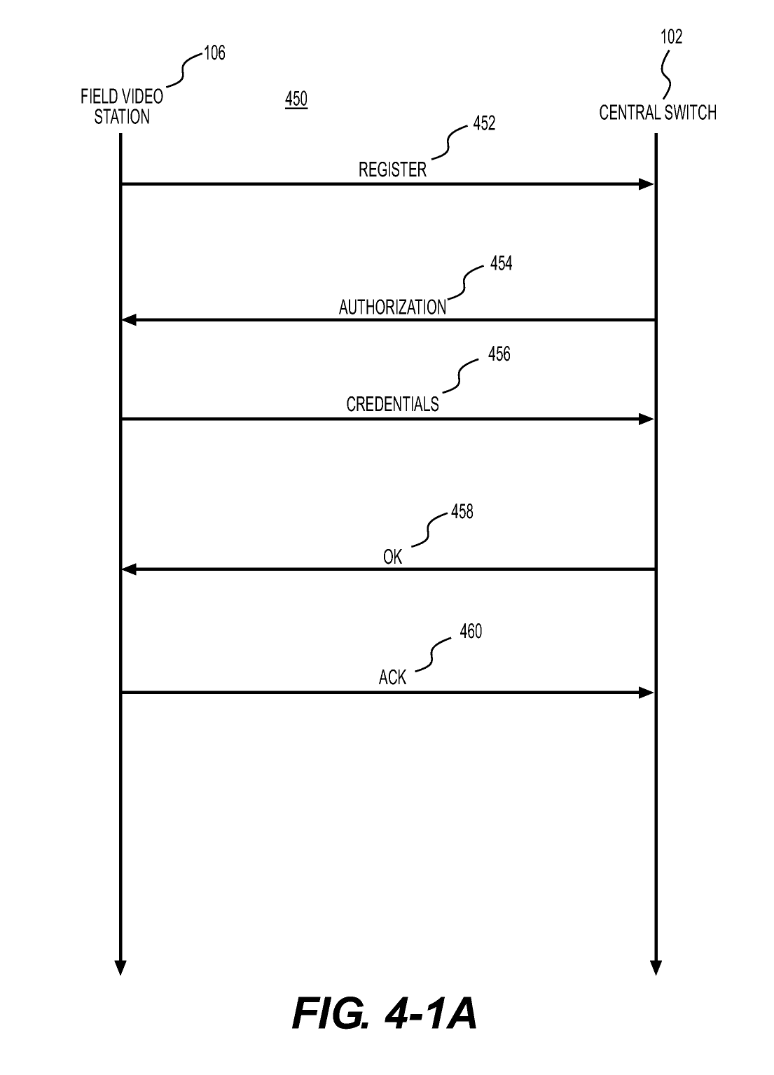

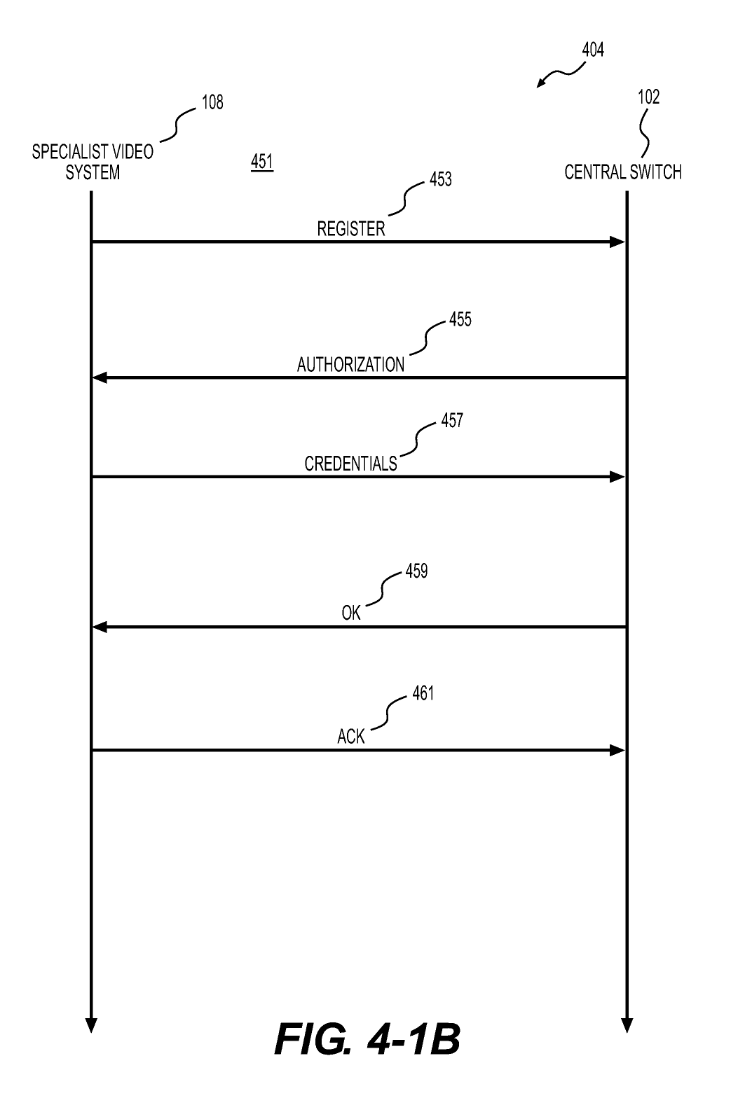

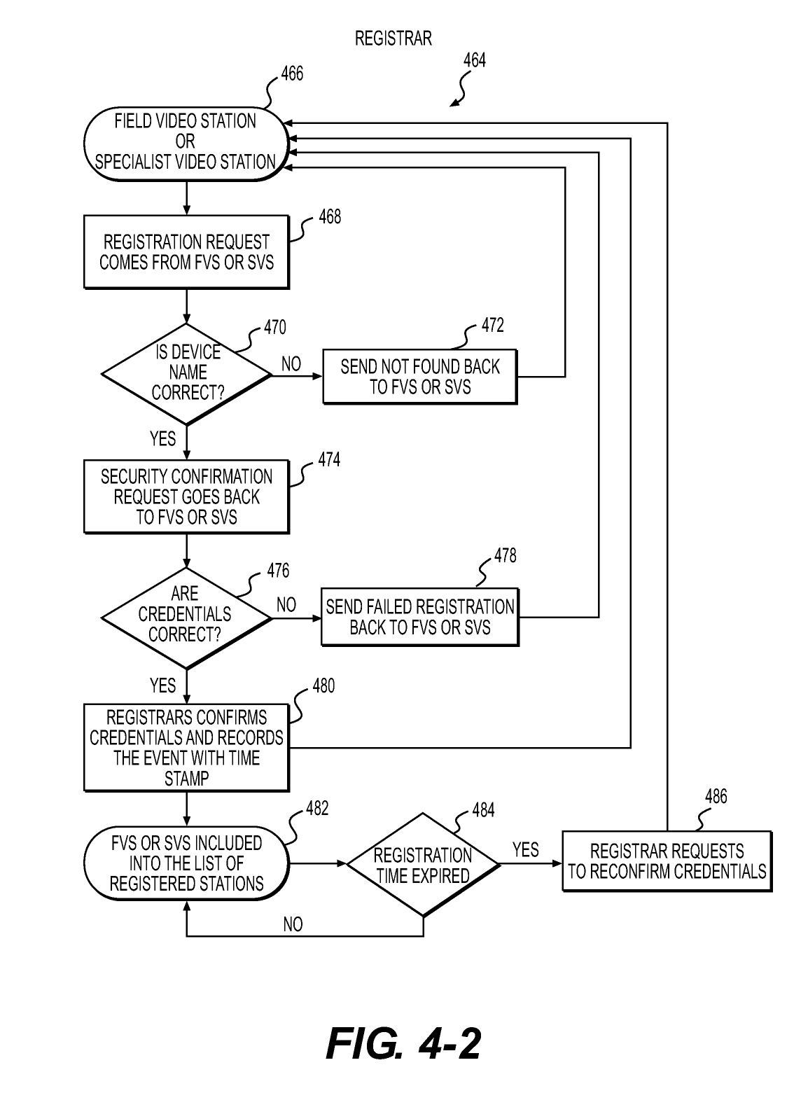

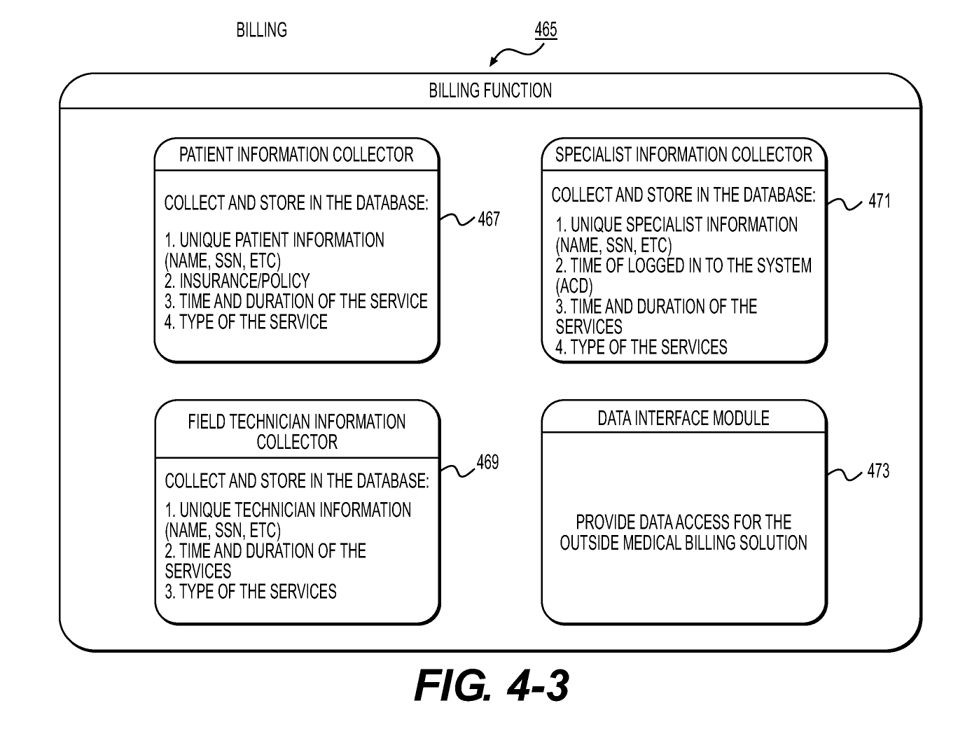

The ACD function services requests from a FVS to identify a specialist for providing medical services to a patient. The ACD is connected to the database 302 via the connection 305, and will be described hereinafter in FIG. 4-1

The Registrar function 306 is connected to the database via connection 307 and involves software for (1) receiving, recording, listing specialists and their credentials, and (2) describing SVS communication protocol in terms of device name; device authorization name, device password, etc. The specialist credentials include, but are not limited to, medical skills, experience, acceptable insurance, fees and other practice information for input to the ACD. The Registrar function will be further described hereinafter in FIG. 4-2.

The Billing function 308 is connected to the database via connection 309 and involves software for receiving, recording, and listing of medical services provided to patients. The billing function includes, but is not limited to, automating the matching of delivered patient medical services to specialist fees for such services; submitting claims to the patient insurance provider, and billing the patient for fees not covered by the insurance company. The billing function will be further described hereinafter in FIG. 4-3.

Turning to FIG. 4-1, taken in conjunction with FIGS. 1 and 3 the ACD function 304 is described in a process 400. An operation 402 activates the ACD function when a registered specialist 134 (See FIG. 1) logs on to the ACD to provide services to patients and others. An operation 404 checks the credentials of the specialist. An operation 406 stores the specialist credentials in a region of a memory 408 included in the central switch 102. The specialist is listed with other specialist in the memory 408 in at least one queues 410¹ . . . 410^{N}, according to specialty.

A service request for a specialist is submitted to the ACD by the Field Video Station 106 in an operation 412. Typically, the service request is submitted by a technician in behalf of a patient. An operation 414 provides the technician 116 with listings 414 of specialist 134 from which to choose a specialist. A test 416 is performed to identify available specialists in the lists 414. In the event a preferred specialist is available, the specialist is contacted by the technician to initiate specialty services. The specialist is removed from the queues 410 as unavailable in an operation 418. Should a specialist not be available for the request, an operation 420 stores the request until a matching specialist is available in the queue list 414, whereupon the program continues at the operation 418. An operation 422 returns the specialist to the queue(s) when the services are completed. The specialist, upon request, may be removed from the queues in an operation 422, whereupon the program ends.

FIG. 4-1A in conjunction with FIGS. 1 and 3 describe the SIP protocol for connecting the field video station (FVS) 106 to the central switch 102 in a process 450. The FVS initiates a Register request 452 to the central switch. The Register request provides the current address and the URLs for the FVS to receive calls. The request includes a device name and other particulars of the FVS for establishing communications with the central switch. The central switch in an operation 454 issues an authorization message for the FVS to proceed with messaging. The FVS in an operation 456 provides credentials for establishing a secure connection between the FVS and the central switch. An Ok message is issued by the central switch in an operation 458 indicating the credentials are correct. The FVS issues an Ack message in an operation 460 confirming that it received the Ok message. The FVS and the central switch are now connected for further messaging. The connection is terminated when the messaging ends.

FIG. 4-1B in conjunction with FIGS. 1 and 3 describe a SIP signaling process 451 for connecting the specialist video station (SVS) to the central switch. The SVS issues a Register request 453 providing the current address and the URLs for the SVS to receive calls. The request includes a device name and other particulars of the SVS for establishing communications with the central switch. The central switch issues an Authorization to the SVS for message exchange to continue in an operation 455. The SVS submits specialist credentials in an operation 457. The credentials include elements to establish a secure connection between the SVS and the central switch. An Ok message is issued by the central switch in an operation 458 indicating the credentials are correct. The FVS sends an Ack message in an operation 460 confirming that it received the Ok message. The FVS and the central switch are now connected for further messaging. The connection is terminated when the messaging ends.

Turning to FIG. 4-2, the Registrar function 308 will be described in a process 464 taken in conjunction with FIGS. 1 and 3. The process is initiated by a field video station or a specialist video station 466 communicating with the Registrar function via the network 104. A registration request is sent by the FVS or SVS to the Registrar function in an operation 468. A test 470 is performed by the Registrar function to determine the correctness of an FVS or SVS name submitted in their connection to the central switch, described in FIGS. 4-1A and B. A “No” condition sends the failed request back to the FVS or SVS in an operation 472 for registration with the central switch if the Device Name is not correct. A “Yes” condition for the test 470 initiates a security confirmation request from the Registrar to the FVS or SVS in an operation 474. A test 476 is performed to determine the correctness of the FVS or SVS security credentials, previously submitted in their registration with the central switch, as described in FIGS. 4-1A and B. A “No” condition initiates an operation 478 to send the failed registration request back to the FVS or SVS device for registering security credentials with the central switch, as described in FIGS. 4-1A and B. A “Yes” condition initiates an operation 480 wherein the Registrar confirms the credentials and records the event with a time stamp. An operation 482 incorporates the FVS or SVS in the list of registered stations for a predetermined time. A test 484 is performed to determine if the registration period has expired. A “No” condition returns the registration to the operation 458 for restoration to the list. A “Yes” condition initiates an operation 486 requesting the FVS and SVS to reconfirm credentials with the central switch, after which the process ends.

Billing Function:

Turning to FIG. 4-3, the Billing function 306 is described in a process 465 comprising software modules for collecting patient information 467; technician information 469; specialist information 471 and a data interface 473. The collected information enables invoices to be generated for payment of services rendered to the patient by the servicing parties, as well as payments to the servicing parties for work performed and/or equipment used for example.

The patient information module 467 collects and stores information in a database, (e.g., the database 302) related to the patient receiving services from the technician; the specialist, and a medical center. The collected patient information includes, but is not limited to, (1) a description of the patient's name, Social Security number, address, telephone number, etc.; (2) insurance information applicable to the patient's medical services; (3) time and duration of the services provided, and (4) the type of service provided.

The technician information module 469 collects and stores information in a database. The information includes, but is not limited to, (1) a description of the technician providing services to the patient; (2) the technician's name, Social Security number, address, telephone number, etc.; (3) the time and duration of the services provided by the technician, and (4) the type of services provided by the technician.

The specialist information module 471 collects and stores information in a database. The information includes, but is not limited to, (1) the specialist's name, Social Security number, address, telephone number, etc.; (2) the time the specialist logged into the ACD system; (3) the time and duration of the services provided and (4) the type of specialist services provided.

An interface module 473 provides data access to an outside authorized medical billing service to prepare and submit invoices for services rendered to the patient. The invoices are in behalf of the technician; specialist, medical center and others for payment of services provided to the patient. The invoices also serve as a basis for reimbursement by the insurance company, to the extent the insurance policy provides coverage of the patient.

During the performance of services, the patient/technician and the specialist interact via the FVS 106 and the SVS 108, the specialist viewing the patient/technician, medical device and interacting with the patient/technician via the streaming video and the two-way audio connection connections 120 and 122. The specialist is able to view the medical device test results on his station 108; diagnose the patient's medical condition; instruct nursing personnel at the station in the treatment of the patient and instruct the technician to modify the operation of the medical device, if needed, all the while the specialist is remotely located from the patient, technician, nursing personnel and the medical device servicing the patient.

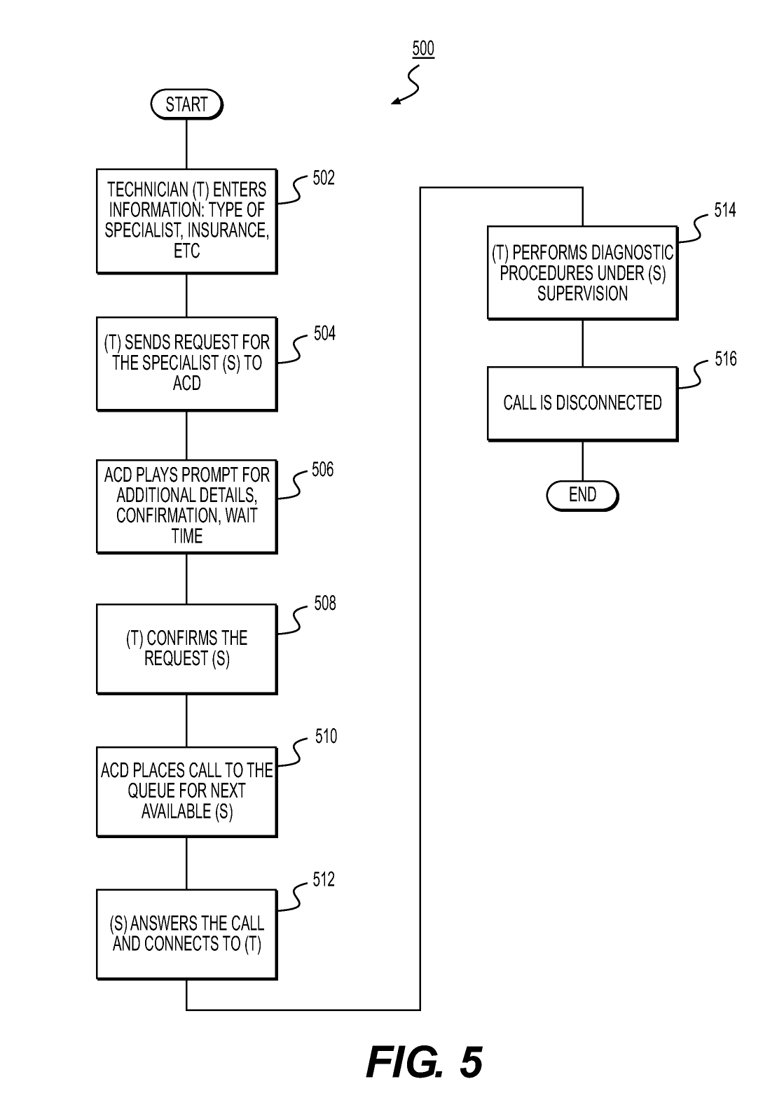

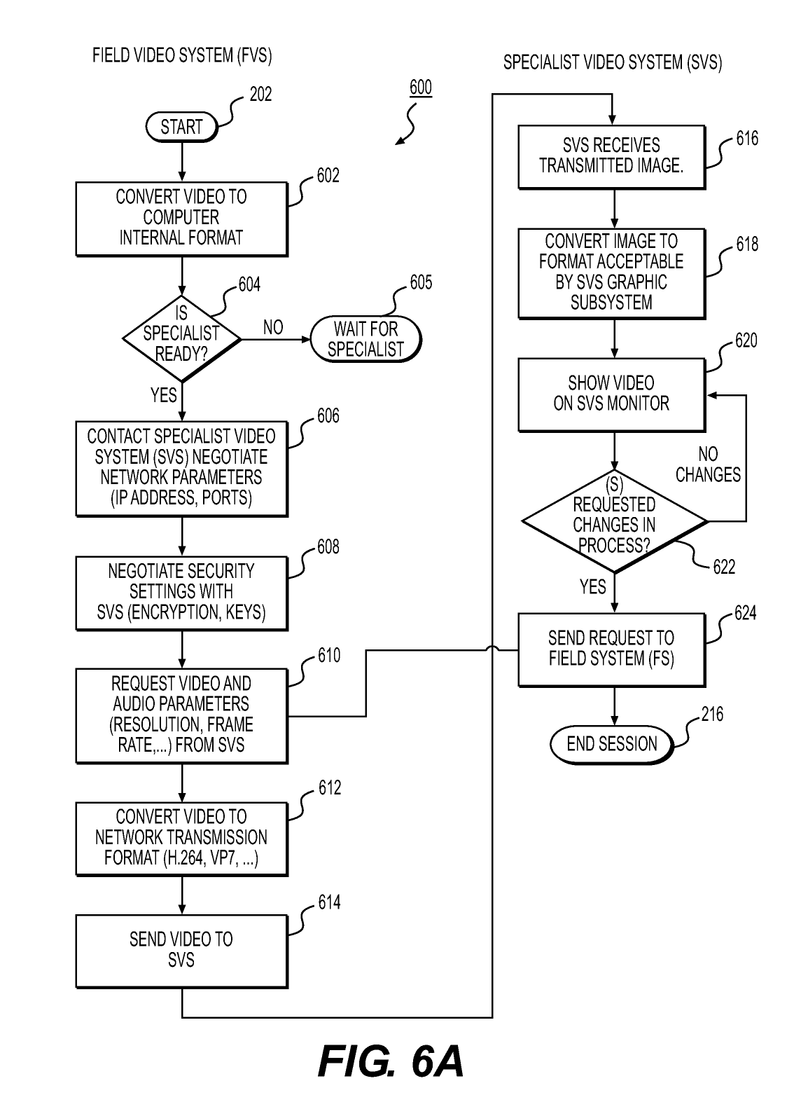

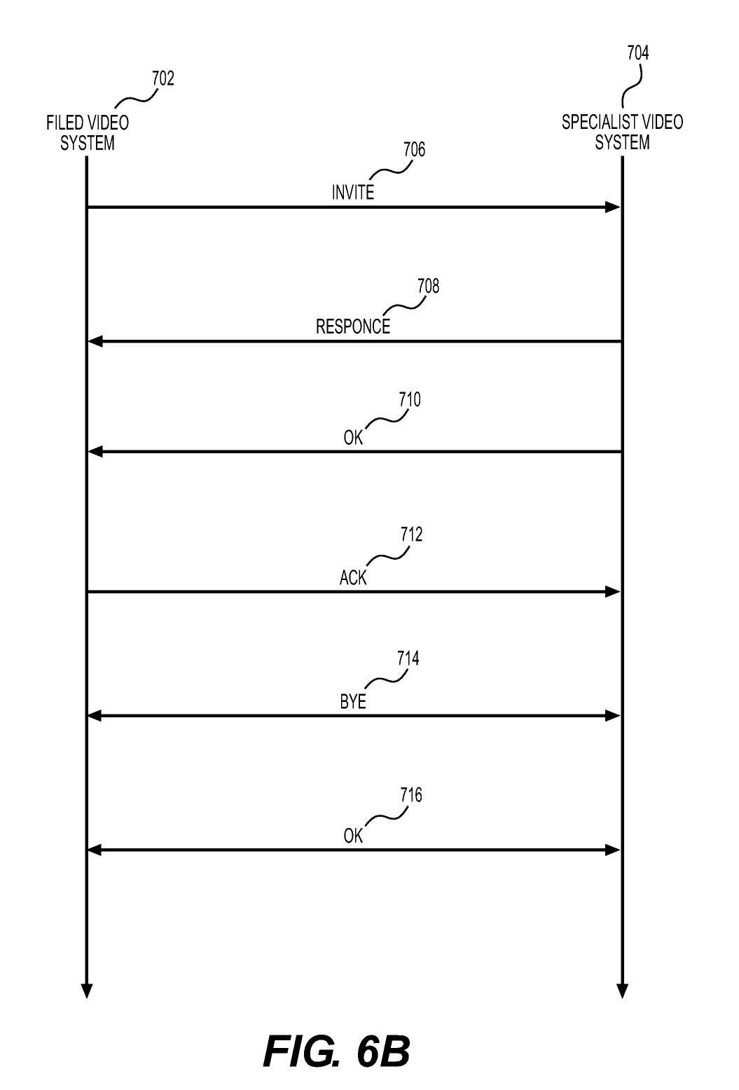

The operation of FIG. 1 will be further described in conjunction with FIGS. 5 through 6A, as follows:

FIG. 5 is a process 500 further describing a technician operating a medical device servicing a patent requesting a remote specialist for diagnosis and treatment of a patient.

An operation 502 involves the technician preparing a request for services from a remote specialist, the request including the type of specialist, insurance status and other information for acceptance by the remote specialist.

An operation 504 sends the request for the specialist to the automatic call distributor (ACD).

An operation 506 involves the ACD prompting the technician for additional details, confirmation and provides a wait time for response, if necessary.

An operation 508 involves the technician confirming the request information for the ACD.

An operation 510 involves the ACD accessing listings of specialist in queues stored in a management system 300 (See FIG. 3), according to their specialty for the next available specialist requested by the technician.

An operation 512 involves the next available specialist receiving and connecting to the technician for receiving information regarding the patient's status.

An operation 514 involves the technician performing diagnostic procedure on the patient under the specialist supervision.

An operation 516 terminates the connection between the specialist and technician after completion of the diagnostic procedures.

FIG. 6 describes a process 600 for the delivery of streaming data from a station to a remote specialist after the FVS and SVS are connected to each other over a direct link or the network 104 or by any other means.

An operation 602 transmits FVS streaming video in the form of electrical, ultrasound, optical or like signal from the medical device for delivery to the local computer 114 using commercially available software and hardware to initiate streaming video transmission to the specialist via a FVS/SVS connection.

An operation 604 determines whether or not the specialist is ready to receive streaming video and if not, the process in an operation 605 waits for the specialist to indicate ready to receive video transmission.

An operation 606 involves the FVS/SVS negotiating network parameters, including IP address, ports to use.

An operation 608 involves the FVS/SVS negotiating security settings including encryption, keys, etc.

An operation 610 is conducted by the FVS to request the video and audio parameters including resolution and frame rate from the SVS.

An operation 612 converts the streaming video signal from the medical device to H.264/MPEG-4 AVC or other video transmission format.

An operation 614 transmits the streaming video and audio signal to the SVS.

An operation 616 involves the SVS receiving the transmission image from the FVS.

An operation 618 is converting the image to the format that SVS can display on the screen and/or store on a storage device, e.g., a hard drive.

An operation 620 involves the SVS displaying the received video on the specialist monitor.

An operation 622 allows the specialist to enter changes in video parameters, e.g., resolution, frame rate, etc.

An operation 624 sends the requested changes to the operation 610. Changes and parameters accepted by the operation 610 are passed to the operation 620 via the intervening operations 612, 614, 616 and 618.

An operation 626 ends the process session, after the changes have been installed and the test finished.

Summarizing, applicant has disclosed a Medical Video Call Distributor 100 enabling a remote specialist at a Specialist Video Station (SVS) to diagnose and treat patients at different Field Video Station (FVS), one at a time, via a network including a central switch. The specialist is able to view and alter medical equipment operated by an operator, typically a technician servicing the patient via one way streaming video and two way streaming audio. An automatic call distributor included in the central switch identifies specialists, including qualifications, for selection by the technician to treat a patient. The network parameters for the SVS and the FVS can be automatically negotiated via software. Likewise, the video parameters can be automatically adjusted for video codec, resolution, frame rate, frame geometry. The service provides the specialist the ability to change video parameters while viewing the streaming video on a monitor serviced by a camera at the station viewing the patient, medical device, and operator.

While the invention has been described in a preferred embodiment, various changes can be made therein by those skilled in the art without departing from the spirit and scope of the disclosed invention.

What is claimed is:

1. A system, comprising:
a first video station coupled to a network and adapted for two-way audio communication; the first station including a medical device operated by an operator for servicing a patient and generating test data; a camera; and a local computer processing test and camera data as streaming one way video for transmission to the network along with two-way streaming audio communication;
a second video station operated by a specialist and coupled to the network;
the second video station remotely located from the first video station; the second station including a processor for receiving, converting and displaying the streaming data; the second video station coupled to the network for two-way audio communication; and
a central switch including a management system coupled to the network,
the first and second video stations interacting via the network after the specialist registers with the management system, and is selected by the operator; the specialist able to view, diagnose and counsel the patient; instruct the operator operating the medical device, and change communication and video parameters during the interaction.

2. The system of claim 1 further comprising:
an automatic call distributor (ACD) function included in the management system for identifying specialists, including qualifications, for selection by the operator to treat the patient.

3. The system of claim 2 wherein specialist are listed by specialty and stored in a region of a memory included in the central switch.

4. The system of claim 1 wherein the management system includes a billing function.

5. The system of claim 1 wherein the management system includes a registrar function.

6. The system of claim 1 wherein the specialist views, diagnoses, counsels the patient and instructs the operator in the operation of the medical device.

7. The system of claim 1 wherein the first video station further includes a two-way communication device.

8. The system of claim 1 wherein the network is a distributed information network coupled to each first and second video station via a connection for one-way video; two-way audio and signaling among the central switch, the first video station and the second video station.

9. The system of claim 8 wherein a signaling protocol is selected from the group comprising Session Initiated Protocol; Transaction Control Protocol; User Datagram Protocol; MGCP and International Telecommunication Union (ITU) H.323 standard that defines the protocols to provide audio-visual communication sessions on any packet network.

10. The system of claim 1 wherein the specialist adjust the video and audio parameters.

11. A method, comprising:
coupling a first video station to a network, the first station adapted for two-way audio communication; the first station including a medical device operated by an operator for servicing a patient and generating test data; a camera; and a local computer processing test and camera data as streaming video for transmission to the network along with two-way audio communication;
coupling a second video station operated by a specialist to the network; the second video station remotely located from the first video station; the second station including a processor for receiving, converting and displaying the streaming data; the second video station adapted for two-way audio communication; and
coupling a central switch including a management system to the network,
the first and second video stations interacting via the network after the specialist registers with the management system, and is selected by the operator; the specialist able to view, diagnose and counsel the patient; instruct the operator operating the medical device, and change communication and video parameters during the interaction.

12. The method of claim 11 further comprising:
installing an automatic call distributor (ACD) function in the management system for identifying specialists, including qualifications, for selection by the operator to treat the patient.

13. The method of claim 12 further comprising:
listing specialist by specialty and storing the list in a region of a memory included in the central switch.

14. The method of claim 11 further comprising:
installing a billing function in the management system

15. The method of claim 11 further comprising:
installing a registrar function in the management system.

16. The method of claim 11 further comprising:
viewing, diagnosing, counseling a patient and instructing an operator in the operation of the medical device by a specialist.

17. The method of claim 11 further comprising:
installing a two-way communication device in the first and second video stations.

18. The method of claim 11 further comprising:
coupling the first and second video station to a distributed information network via a connection for one-way video; two-way audio and signaling among the central switch, the first video station and the second video station.

19. The method of claim 18 further comprising
selecting a signaling protocol from the group comprising Session Initiated Protocol; Transaction Control Protocol, User Datagram Protocol.

20. The method of claim 11 further comprises:
adjusting the video and audio parameters by the specialist.

21. A medium containing program instructions, executable in a computer system for patient monitoring, diagnosis and treatment of patients via remote specialists, comprising:
program instructions for coupling a first video station to a network, the first station adapted for two-way audio communication; the first station including a medical device operated by an operator for servicing a patient and generating test data; a camera; and a local computer processing test and camera data as streaming video for transmission to the network along with two-way audio communication;
program instructions for coupling a second video station operated by a specialist to the network; the second video station remotely located from the first video station; the second station including a processor for receiving, converting and displaying the streaming data; the second video station adapted for two-way audio communication; and
program instructions for coupling a central switch including a management system to the network, and
program instructions for interacting the first and second video stations via the network after the specialist registers with the management system, and is selected by the operator; the specialist able to view, diagnose and counsel the patient; instruct the operator operating the medical device, and change communication and video parameters during the interaction.
